(19) United States
(12) Patent Application Publication
(10) Pub. No.: US 2007/0091177 A1
(43) Pub. Date: Apr. 26, 2007

(54) Remote unattended camera and computer integrated security system

(75) Inventors: James D. West, Los Alamos, NM (US); Kelly D. Michel, Santa Fe, NM (US); David G. Pelowitz, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/257,547

(22) Filed: Oct. 24, 2005

(51) Int. Cl. H04N 7/18; H04N 5/225

(52) U.S. Cl. 348/152; 348/207.11

(57) ABSTRACT

A remote unattended camera and computer integrated security system that uses: a computer to process and archive alarm and photographic data; at least one media storage device; at least one network camera for storing and transmitting video and still pictures; a hardware virtual private network firewall for secure review data transfers; a transfer switch; an operating system providing user interface functions; a power source that provides power to said remote unattended camera and computer integrated security system; an enclosure that is tamper resistant, and security seals that provide indication of tampering.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to camera surveillance, and, more particularly, to a camera system providing secure authenticated video and photographic evidentiary data.

### BACKGROUND OF THE INVENTION

Closed circuit video surveillance began in 1965 using a TV monitor and a video camera. The invention of the VCR allowed for the taping and archiving of video camera data using magnetic tape storage devices. Businesses prone to theft and robbery began using this technology as a deterrent. The insurance industry also found this technology compelling for use as a means of proving security and false insurance claims. Private citizens began using analog camera technology as deterrents against child abuse while their children were under care in their homes by other parties.

Once introduced, digital technology soon became the standard for video surveillance, as digital technology allowed for sharper, clearer, and higher resolution images and recording. Over time storage systems became more robust and added the ability for longer recording times and less required storage space for the recording media. Camera systems have been combined with computer systems to allow for higher recording frame rates, ease of use and editing. Associated technologies have continued to advance creating smaller cameras, and higher volume storage systems that are secure and relatively small and affordable. However, new surveillance systems continue to be proprietary using either embedded proprietary operating systems or proprietary hardware or both. Considering both the engineering and usability aspects of new system development, the continued development of proprietary systems lends no great advancements that can be quantified for any reason other than additional profits to the manufacturer through the added cost of technical support and software suite licensing fees.

Along with the advent of digital recording came the ability to digitally alter the images produced. The ability to alter images brings into question the legitimacy of the use of digital video data for use in surveillance and as proper evidence in legal proceedings.

Current prior art in the video surveillance and security industry fails to address specific needs for data security and integrity at specific points. Prior art systems incorporate several freestanding components that contain a security risk inherently due to the ease in accessibility of each systems required components. To address this concern, the present invention Remote Unattended Camera and Computer Integrated Security System (RUCCISS) is a secure, totally enclosed, tamper proof system that is physically protected from data manipulation, data spoofing (spoofing defined as injecting a data signal into a communications system by an adversary to fool or mislead the data reviewer), and subversion through system shutdown or signal jamming.

U.S Patent Application No. 20040085446, Method for Secured Video Signal Transmission for Video Surveillance System, by Ho-sang Park, and U.S. Patent Application No. 20040085445, Apparatus for Secured Video Signal Transmission for Video Surveillance System, by Ho-sang Park, teach a video data security transmission system that encrypts the video signal stream then de-encrypts the data as part of the storage means. This process prevents the use of any viable evidence when the de-encryption algorithm is applied because the de-encrypted evidence may be subjected to digital manipulation.

Whereas, the present invention RUCCISS is an all in one package that contains the evidentiary data in an evidence vault, which is to say a sealed container that is secure from digital and physical tampering up to the point of system destruction. The original evidentiary data is always encrypted and securely stored inside the system, and, thus, can be authenticated in real time as it is presented as testimonial evidence

U.S. Patent Application No. 20040080615, Digital Video Security System, by Larry Klein et al., teaches the process of data collection and comparison of the data to provide a data set that presents the observer with the changes in the video scene so that the observer can discern if a security infraction has occurred (motion detection). This is a key process in the acquisition of surveillance data, but does not provide a means of implementing encryption or authentication algorithms as a means of insuring data integrity.

U.S. Patent Application No. 20040066456, Visual Imaging Network Systems and Methods, by David Read, teaches a combination of theories of operating a security surveillance system. The system stores images on a server that is directly accessible via web servers, and the system transmits data via external ethernet connection over the internet relying on encryption algorithms as the sole security measure before storage. A secure image is never stored locally, all data is transmitted off the data-gathering platform and assumed secure. However, the taught system de-encrypts the data, as it is stored on a web server. Unfortunately, the inherent availability and access of a web server to provide information to other users on a computer network permanently destroys any possibility of maintaining the integrity of collected data for evidentiary purposes.

U.S. Patent Application No. 20030085998, Video monitoring and security system, Luis G. Ramirez-Diaz et al., teaches yet another motion detection system that displays multiple picture frames from multiple cameras at the same time. This system does not address any authentication or secure storage of the authenticated picture data. The system taught is also a combination of multiple components in different locations that allows for easier tampering as there are now multiple points to intercept or “tap into” the data stream and either manipulate or change the data before it is stored.

Various objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a remote unattended camera and computer integrated security system that uses: a computer to process and archive alarm and photographic data; at least one media storage device; at least one network camera for storing and transmitting video and still pictures; a hardware virtual private network firewall for secure review data transfers; a transfer switch; an operating system providing user interface functions; a power source that provides power to said remote unattended camera and computer integrated security system; an enclosure that is tamper resistant, and security seals that provide indication of tampering.

The present invention further provides a method of camera surveillance, that includes the steps of: acquiring an image with a network camera; transferring the image in a digital data stream to a computer; incorporating an authentication algorithm that contains a cryptographic signature into the digital data stream; and, then storing the digital data stream in at least one media storage device.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is an operative schematic of one embodiment of the RUCCISS.

FIG. 2 pictorially shows one embodiment of the RUCCISS enclosure.

FIG. 3 pictorially shows a periscope embodiment of the RUCCISS enclosure.

FIG. 4 pictorially shows a secure RUCCISS network with redundant authenticated cross platform storage.

FIG. 5 is a flowchart of one embodiment of a RUCCISS operation.

### DETAILED DESCRIPTION

The present invention, a Remote Unattended Camera and Computer Integrated Security System (RUCCISS), is the next step in the evolution of the surveillance camera security system. The redundancy and security of this system enables the user to install stand alone or networked camera systems with a minimum requirement of AC power. The configuration options offer a scaleable component camera system that can be upgraded easily.

The RUCCISS is an off the shelf integrated commercial component system, where components upon failure are easily replaceable at low cost. The system is easily maintained in the field, and contains a redundant power supply, redundant data storage, and high capacity data storage utilizing AES-256 bit security encryption algorithms. When properly configured, the RUCCISS is a sealed evidence locker. This sealed evidence locker presents the user with un-tampered evidence. Thus, the RUCCISS is distinguished from prior art products by incorporating all the necessary elements in one stand alone package that is secure from tampering, and, therefore, provides evidentiary data that may be used without question as to validity.

The RUCCISS may be employed as a stand-alone system or a network integrated system. The RUCCISS is low light/no light, night vision capable, and the radiation-hardened security enclosure is resistant to the damaging effects of high radiation fields. The secure removable data storage system allows inspectors to gather data quickly, thus requiring less time spent at remote sites and allowing more time to review the acquired data. Also, inspectors have the capability to perform facility data review remotely from any location over secure data communications systems such as communication satellites. The RUCCISS requires zero or minimal support equipment (e.g. small computer monitor, keyboard, and mouse), no data storage server farms, or the required equipment to operate and maintain a data storage server farm is required.

Hardware

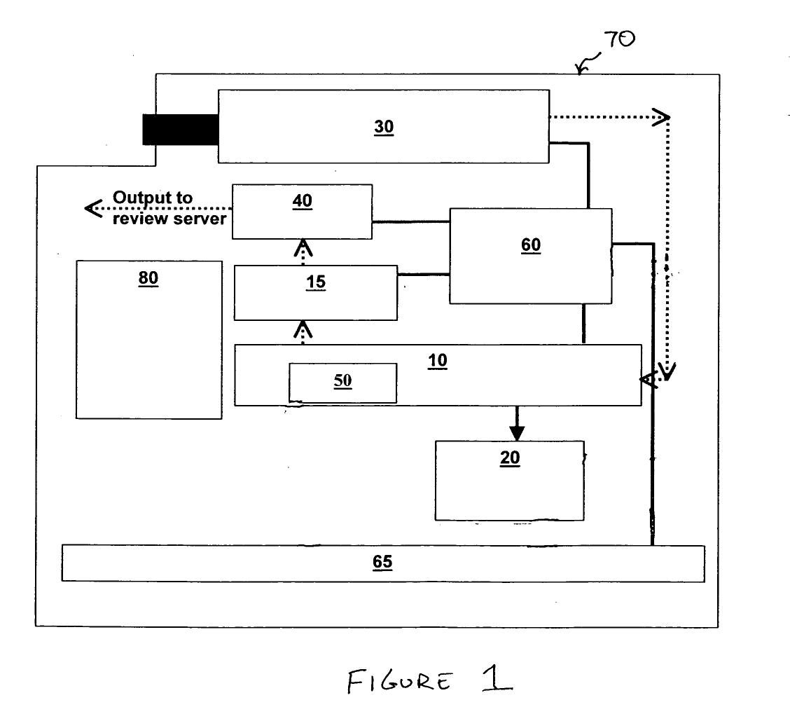

Referring now to FIG. 1, the RUCCISS is comprised of nine component subsystems: (1) miniature computer 10, (2) network switch 15, (3) media storage device 20, (4) network camera 30, (5) hardware virtual private network (VPN)/firewall 40, (6) operating system and review software 50, (7) power system 60, (8) enclosure 70, and (9) security seal 80.

Miniature Single Board Computer (MSBC) 10 is the base of the system. MSBC 10 is a miniaturized single board low power computer system. MSBC 10 has all the capabilities of a desktop computer system packaged into a very small single computer board, most MSBC's are 17 mm×17 mm or smaller and use very little power when compared to the normal computer desktop system. MSBC 10 must have a passive cooling system with no moving parts or active cooling fans because moving parts inherently create failure points and incorporating a fan into a sealed system will lead to opening and recertifying system integrity more often because of a failure of a moving part.

All other components connect to MSBC 10 via standard network connections, e.g. standard RJ-45 Ethernet connectors, (excluding media storage device 20). In one embodiment, power system 60 is a 12 Volt 5 Amp AC-DC power converter. This power converter can be supplied power via a 120 VAC wall outlet or through a battery/charging system.

The Operating System (OS) functions in exactly the same way a desktop computer OS functions. The OS is the user interface for security logging, data storage, data authentication, user troubleshooting, date/time synchronization, data transfer management, and the platform from which the camera system operates. The OS also offers the user the capability to perform secure remote desktop operations for maintenance and updates/upgrades. The OS adds flexibility to the camera system that creates a non-proprietary platform for the implementation of any future software or hardware upgrades installed by the user.

The OS boots and runs from MSBC 10 through a standard cable, e.g. high density 44 pin ribbon cable, that connects media storage device 20 to MSBC 10. Media storage device 20 may be either a flash memory drive or fixed flash memory media. All data collected from camera 30 is stored on a second flash memory drive. Camera 30 is powered from MSBC 10 through a power supply point on MSBC 10 and transfers all data through miniature network switch 15 to MSBC 10.

All data collected from camera 30 is stored encrypted on media storage device 20. The encrypted data may be transferred to a local review computer via VPN/Firewall 40 that is connected to the uplink port on miniature network switch 15. All data transfers into and from the system go through VPN/Firewall 40.

Miniature Computer 10

Miniature computer 10 has the capability to process and archive all alarm/photographic data, and to store the data in secured, removable and non-removable media for redundancy. This architecture eliminates the need for expensive server farms and the supporting equipment required to run and maintain data archival server farms. Currently there are a number of manufacturers producing miniature computers 10 that meet these requirements, examples include the VIA technologies Mini-ITX Single board computer and the Kontron JREX Single Board Computer.

The processor used in miniature computer 10 is based on scalable power requirements and should be rated for a minimum of 1 GHz of processor power. 1 GHz processors are easily able to perform the multiple tasks needed to acquire and store images while performing many other critical functions such as data encryption, storage, replication, and transmission. The minimum supporting media/communications interfaces required are: 3 10/100 network ports, 4 USB 2.0 ports, 1 RS-232 Communication Port, 1 15 Pin HD Video Monitor Port, 1 IEEE 1394 Fire wire Port, 1 ATA Compatible 2 Channel IDE Socket Header, 1 Bootable ATA 2 Channel Compact Flash Drive Socket, 1 Floppy Drive Port, and a standard USB 2.0 Boot supporting flash upgradeable Bios.

Each component is necessary to provide flexibility in the daily use of the camera system. Each component provides troubleshooting and support capabilities as well as upgradeability. For example, USB and RS-23 communications ports provide the ability to utilize an additional GPS system. USB also allows for the installation of larger more flexible media storage systems. Fire wire enables the use of 3CCD high resolution broadcast quality camera systems or a common video recording camera. The 10/100 network ports internal to the camera allow flexibility and high-speed communications as well as upgradeability to fiber optic based and satellite communications.

A minimum single memory socket is used that supports Error Correction Code (ECC)/Double Data Rate Synchronous Dynamic Random-Access Memory (DDR) onboard memory with an expansion capability up to 1 GB. Sound is considered optional, but PS/2 or USB Mouse and Keyboard support are required when using a PC based computer and operating system. The keyboard mouse and monitor are more for setup and field troubleshooting and would not be required for daily operations.

Note that by using IEEE standardized miniature computers 10 the present invention is compatible with numerous peripheral add-ons forming other embodiments, to include, but not limited to: Global Positioning Systems (GPS), Neutron-Gamma-Alpha-Beta Radiation detectors via Universal Serial Bus (USB), discrete i/o communications, parallel communications, RS-232/RS-485 communications, accelerometers, and weather stations.

Network Switch 15

The network switch is a small 4″×4″ computer board that requires low power (12 Volts×300 milliamps=3.6 Watts DC) to perform IEEE standard network 10 Base-T/100 Base-TX communications. The switch has four communications ports and 1 uplink/destination port each port uses standard RJ-45 telephony termination connectors. The network switch is built for industrial implementation and uses the PC-104 board stack architecture standard. A network switch is a basic switchboard where communications inputs from a maximum of five different devices can be connected and two-way communications from the devices are directed to their destination while maintaining an order in the flow of communications packets. This device keeps communications packets from interfering with each other as they are electronically transferred to their addressed destination.

Media Storage Device 20

In one embodiment, miniature computer 10 includes a removable media bootable via USB 2.0, Compact Flash, 2.5″ Flash Memory Drive 23, and Secure Digital (SD) flash memory card 25 as media storage device 20. One factor for booting from removable media is ease in upgradeability that allows a new operating system (OS) with new versions of applications installed by simply removing and installing a new flash drive.

Currently there are a number of non mechanical devices available for off the shelf applications, PCMCIA Flash Drive Cards, Compact Flash Drive Cards, USB 2.0 “Thumb Drive”, and Flash Memory Drives. The current Hard Disk Drive (HDD) technology in common use is mechanical based magnetic storage media. All HDD's consume large amounts of power and are motor driven (moving parts). HDD's can now be replaced with media capable of high volume storage with zero moving parts and low power consumption.

Most new memory storage media is bootable, highly reliable, and MILSPEC rated (temperatures from −60 to +95 C) or industrial rated (temperatures from −40 to +85 C) for high reliability in the most extreme environments. This technology has progressed to highly reliable (1.9 Million Hours MTBF @ Bellcore Issue 6, Method 1, Case 3 testing) low power consumption storage media. It is also available with Security Erase Compliance reliability as specified by NISPOM Department of Defense 5220.22-M, National Security Agency (NSA) 130-2, U.S. Air Force AFSSI 5020, U.S. Army 380-19, and U.S. Navy NAVSO P-5239-26.

2.5″ and 3.5″ Flash Memory Drives (FMD's) using NVRAM are currently available with a storage capacity of up to 151 Gbyte. A 20 Gbyte FMD would be capable of storing up to 3.5 years of data at a write rate of 50 kb (average radiation alarm data and JPEG Picture file size) every 5 minutes, 24 hours a day, 365 days a year. Industrial and Military rated FMD's have a 10 year data integrity rating, built in Error Detection Correction (EDC), and less than 10⁻³⁰ undetected data errors with unlimited read endurance. Typical power use for a FMD is 0.660 μA @ 5VDC (±5%) during write functions. In idle mode current draw is 0.480 μA @ 5 VDC (±5%). FMD's have higher G shock ratings, higher vibration ratings, and require zero airflow cooling. A 151 Gbyte drive weighs 16.4 oz. Read endurance is unlimited and data integrity is rated for 123 years at 100 Gbyte per day erase/write cycles. Flash memory drives are low power, high storage capacity, have zero moving parts, and are superior to current rotating media in both speed and mean time before failure. Memtech® solid-state flash drives are employed in a preferred embodiment; however, other brands are available through several other manufacturers.

Network Camera 30

The market for home and industrial camera security systems is highly competitive and produces new camera models with numerous features on a semi-annual and annual basis. However, there are several minimum requirements for a camera being integrated into a new component system. There are two possible approaches with the camera component. Use a small, affordable camera with minimum electronics and an Original Equipment Manufacturer (OEM) video server board, or an all in one network camera.

In a preferred embodiment, multiple IPix 2.2 Mega pixel 180° Command View dome cameras are used and are compatible with normal light conditions. In yet another embodiment, both the AXIS-2420 Infra Red camera and the IQI3-603 3.3 Mega pixel camera are used for low light applications. The FLIR systems A40 Thermal/Infra Red camera system is compatible for thermal and no light imaging.

Camera 30 used in the present invention may include, but is not limited to, the following capabilities:
Zero light intrusion CCD to lens focal tunnel
5VDC or discrete TTL trigger in and out capability
32 MB minimum onboard NVRAM storage
10/100 TCP/IP based network connectivity
Linux embedded operating system
Low light/no light night vision capable
Infrared incorporated or add on lights
On board video server
Web based on chip configuration utilities that are stored in NVRAM
Remotely re-bootable
Configurable Pre and Post alarm image buffer
Time server synchronization
Image labeling and numbering
Text file configurability
Progressive scanning with a minimum 640×480 resolution @ 0.5 Lux
5-30 Volts DC power requirement at low currant
CS or C mount lens, manually adjustable and locking Iris, Focus, and Zoom adjustment
Minimum industrial operational temperature specification with passive cooling
   Hardware Virtual Private Network (VPN)/Firewall Security 40

Availability of small form factor hardware VPN security devices has increased over the past several years. Today there are a number of small, low power consumption hardware VPN devices that can be used in a component system. All available choices are FIPS 140/Common Criteria compliant, however, only a few are FIPS 140/Common Criteria Certified. The FIPS certification is a benchmarking and testing laboratory that allows manufacturers to certify their product; some Government agencies will only allow for the use of FIPS certified encryption equipment. VPN devices use the Advanced Encryption Standard (AES)-256 bit encryption and Data Encryption Standard (DES)-56, and 168-bit triple DES encryption. In a preferred embodiment, the RUCCISS uses the AES-256 standard.

A majority of hardware VPN appliances provide authentication and access control with Digital Signature Standard (DSS), Diffie-Hellman key exchange, X.509 v.3 digital certificates, and PS Key management. The majority of new hardware VPN appliances also use the Rijndael (Rain Doll) cryptographic algorithm. Recent satellite communications improvements have been tested with this system and work very well for remote administration and monitoring. This capability which implements near real time video image viewing via secure network transmission over unlimited distances enhances security monitoring as never before. The present invention was tested with a Direcway DW-4000-0.098 off the shelf satellite system. This system is commercially available to the public.

Operating System (OS) 50

Two Operating systems appropriate for use in embodiments of the present invention are Windows® and Linux®. Either of the Operating Systems can be embedded into the computer system or installed and used as a normal desktop system. In one embodiment the Linux® operating system is used based on better virus security and lower overall cost. However, when removable media compatibility, software development cost, and application compatibility are considered, Windows® becomes the preferred operating system.

Power/Battery Backup 60

Any stand-alone system must have a highly reliable and redundant power system. Implementing an AC to DC power supply capable of supplying the required 12 VDC from a number of different AC outlet standards throughout the world is currently a simple requirement. A number of high efficiency switch mode power supplies are available with auto voltage/cycle sensing capability. The same power supply can be used to charge a battery backup system. Efficiency of new switch mode torroidal transformer based power supplies create less heat and provide very low noise DC power with up to 90% efficiency.

A number of batteries can be applied to this power system. Currently gel cell, lithium ion, and lithium ion polymer batteries are readily available from several manufactures with a large choice of vendors. The newer battery technologies available today are smaller and have very low or zero hydrogen generation during charge cycle. They provide a high amp hour current draw capacity and charge quickly with very low charge memory effect. It is possible to use lithium ion polymer batteries (LIP) as a neutron moderation material.

Used in this manner, several batteries in series could be utilized to provide battery backup power to the RUCCISS system in the case of AC power failure. Using this type of battery in this configuration will also increase battery life and decrease material weight used for shielding purposes. For example, using 5 LIP batteries will provide 55 Amp hours at 12 Volts DC. A mobile technology Central Processing Unit (CPU) allows for scaled computer processing during AC power interruptions. As a very conservative estimate, it is quite possible to provide up to 1 week of battery power. This system inherently lends itself to use in remote areas that are not on the grid. This system can also be operated via a 12 Volt DC solar power system.

Enclosure 70

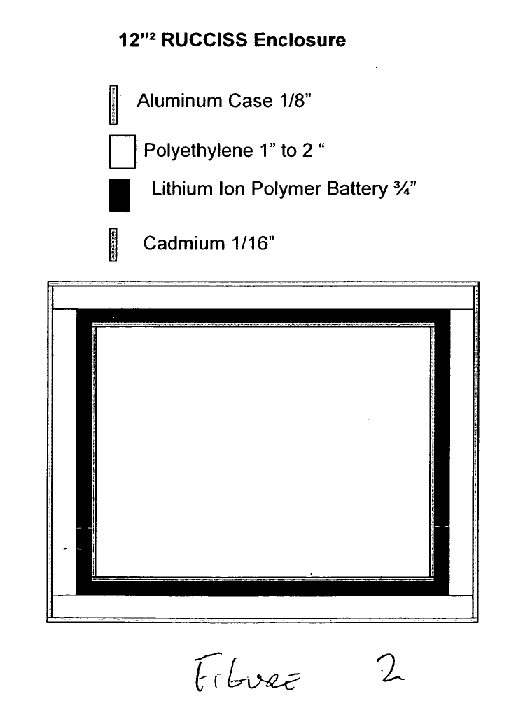

Referring to FIG. 2, one embodiment of enclosure 70 that is radiation hardened includes aluminum case 72, layer of polyethylene 74, lithium polymer battery 76, and layer of cadmium 78. The footprint for an integrated camera system capable of years of standalone service is surprisingly small. The enclosure is tamper resistant and shields the system from the damaging effects of neutron radiation. 100% shielding is not feasible due to the added weight and volume to the camera housing. However, the amount of ionizing radiation exposure to the component system can be significantly reduced. Five LIP batteries combined with polyethylene and cadmium can be used as shielding.

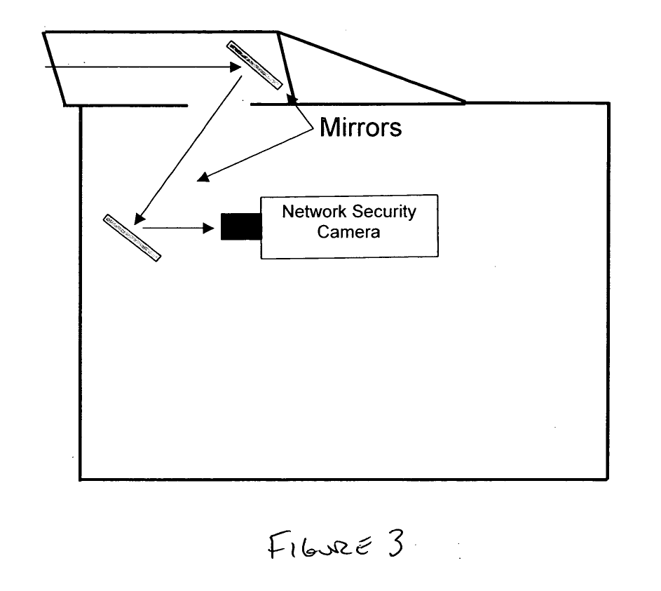

Referring now to FIG. 3, enclosure 70 may include periscope device 75, using high-resolution mirrors 76 to enhance the flexibility of camera 30 positioning. This flexibility will increase the survivability of camera 30 in a high radiation environment by shielding the camera from a large percentage of ionizing radiation.

Security Seals 80

A variety of security seals are available for use. A preferred embodiment uses a Time Trap seal. This new technology will afford the user with a low cost anti tamper device that is fully reusable. This device is an anti-evidence based tamper indicator. To the laymen this is an innocuous device that poses no threat or indication of tampering. However when the Time Trap determines that it has been violated it turns on its liquid crystal display, the display then alternates between showing the hash for that time and the time intrusion was detected. There is a hash for each minute. Only the user knows the correct hash algorithm values for future times. The future hash values are erased when the seal detects intrusion. This eliminates the possibility of counterfeiting the seal hardware. Anyone other than the user does not know what the seal should display when opened by the user.

RUCCISS Field Deployment

RUCCISS can be deployed in number of operational facilities to include nuclear facilities with high radiation fields. A typical field deployment could consist of one or more camera systems operating independently of the others. However to fully utilize the systems capability a multiple node network using several systems that store all collected data locally and remotely on each network node results in a redundant network data storage system, i.e., a redundant array of Independent disks. This reduces the need for data collection systems and also inherently reduces equipment needs and failure points.

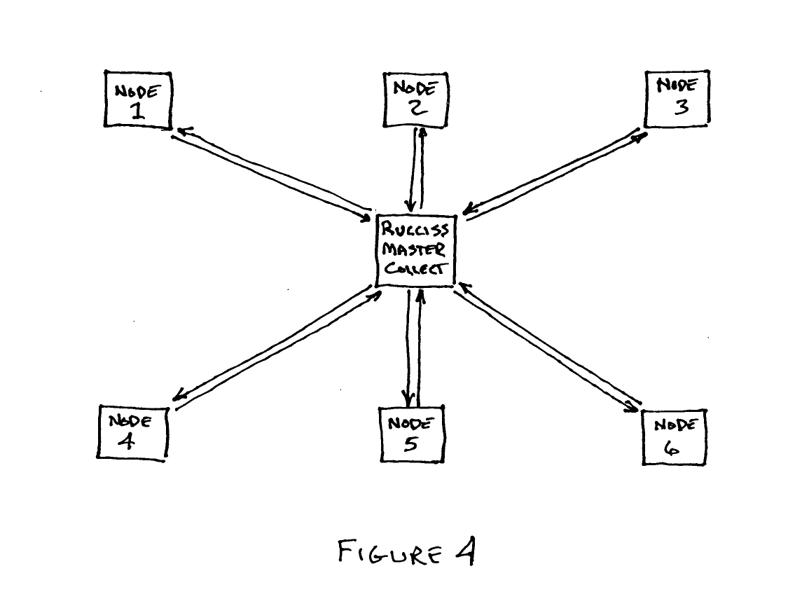

Referring now to FIG. 4 that shows a secure RUCCISS network with redundant authenticated cross platform storage. All collected data is stored locally and remotely on each system creating a network raid array. All data is transmitted through VPN encryption and stored authenticated. Each slave node and master defines a complete RUCCISS network. Each slave node is configured using a VPN and non-routable network address. All incoming network communications go through the master collect node VPN. Should there be a hardware failure all system data is redundant on each node up to the point of failure.

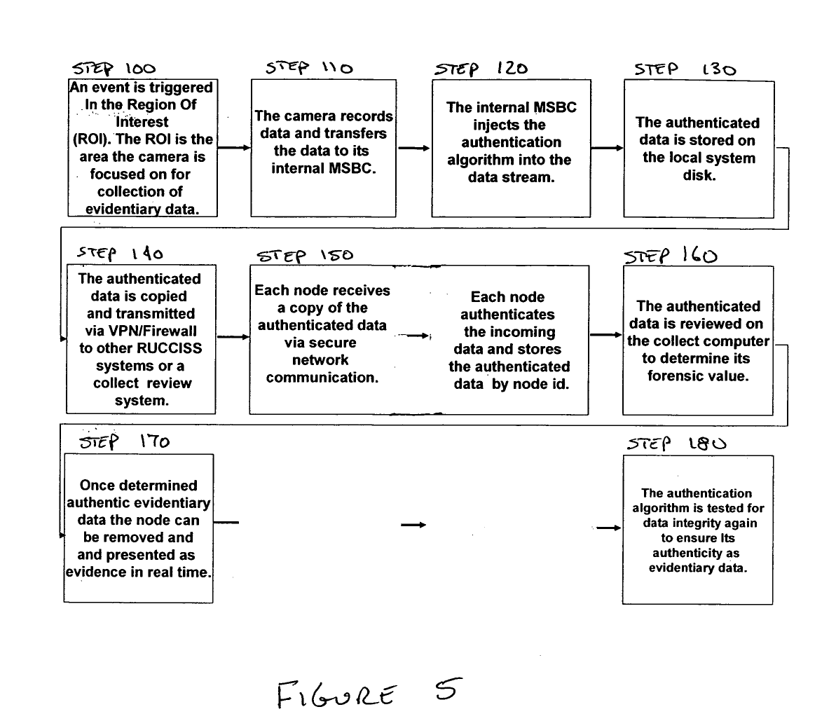

Referring now to FIG. 5 showing a flowchart of one embodiment of a RUCCISS operation. While the system is completely flexible in form and function this flowchart is used to explain basic system operation. First, in Step 100, an event occurs in a region of interest (ROI) that is acquired by network camera 30 that is located at that ROI. In Step 110, network camera 30 records and transfers the acquired image digitally to MSBC 10 where in Step 120 an authentication algorithm is incorporated into the digital data stream that is then stored on media storage device 20 in Step 130.

In Step 140 the authenticated data is transmitted and copied via VPN/firewall to other RUCCISS nodes or a collect review system that is defined as a standard desktop or server with a VPN configured to communicate securely with the RUCCISS nodes. In Step 150, each node receives, copies, and stores the authenticated data by labeling the data with the node ID that acquired the data. In Step 160, the stored authenticated dated is reviewed by system operators on the collect computer to ensure the acquired data is consistent and correctly authenticated.

Now, in Step 170, the authenticated evidentiary data from a given node can be removed and presented as un-tampered evidence. If a question arises as to tampering, inspecting the Time Trap seal provides proof of tampering. Finally, in Step 180, the authentication algorithm may be tested for data integrity to ensure that the evidentiary data is bonafide by checking the cryptographic signature of the authentication algorithm. This process demonstrates authenticity by matching a known secure authentication signature to the authentication signature on the data in question.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A remote unattended camera and computer integrated security system, comprising:
a. a computer to process and archive alarm and photographic data;
b. at least one media storage device;
c. at least one network camera for storing and transmitting video and still pictures;
d. a hardware virtual private network (VPN)/firewall for secure review data transfers;
e. a transfer switch;
f. an operating system providing user interface functions;
g. a power source that provides power to said remote unattended camera and computer integrated security system;
h. an enclosure that is tamper resistant; and,
i. security seals that provide indication of tampering.

2. The remote unattended camera and computer integrated security system of claim 1, where said media storage device is selected from the group consisting of a removable flash memory drive and a fixed flash memory media.

3. The remote unattended camera and computer integrated security system of claim 1, where said at least one network camera is a plurality of network cameras.

4. The remote unattended camera and computer integrated security system of claim 1, where said at least one network camera is selected from the group consisting of a color camera, an infra-red camera, and a thermal imaging camera.

5. The remote unattended camera and computer integrated security system of claim 1, where said power source further includes a battery backup system.

6. The remote unattended camera and computer integrated security system of claim 5, where said battery backup system is selected from the group consisting of gel cell batteries, lithium ion batteries, and lithium ion polymer batteries.

7. The remote unattended camera and computer integrated security system of claim 5, further including a battery charger to recharge said battery backup system.

8. The remote unattended camera and computer integrated security system of claim 1, where said power source is a solar power source.

9. The remote unattended camera and computer integrated security system of claim 1, where said enclosure includes an optical periscope to shield said network camera system from ionizing radiation.

10. The remote unattended camera and computer integrated security system of claim 1, further including a miniature GPS receiver system to enable remote location uplink and time synchronization.

11. The remote unattended camera and computer integrated security system of claim 1, further including a satellite dish uplink for remote location uplink that provides high speed connectivity for state of health monitoring, data review, and alarm/alert reaction.

12. A method of camera surveillance, comprising:
a. acquiring an image with a network camera;
b. transferring said image in a digital data stream to a computer;
c. incorporating an authentication algorithm that contains a cryptographic signature into said digital data stream; and,
d. storing said digital data stream in at least one media storage device.

13. The method of camera surveillance in claim 12, further comprising transmitting said digital data stream to other nodes or a collect review system.

14. The method of camera surveillance in claim 12, further comprising reviewing said digital data stream to ensure said digital data is consistent and correctly authenticated.

15. The method of camera surveillance in claim 12, further comprising testing said digital data stream to ensure said data is bonafide by reviewing said cryptographic signature.
